(19) United States
(12) Patent Application Publication
(10) Pub. No.: US 2009/0260044 A1
(43) Pub. Date: Oct. 15, 2009

(54) INTEGRATION SYSTEM OF DIGITAL CONTENT AND SERVICES

(75) Inventors: CHUN-WEN WANG, Tu-Cheng (TW); CHIN-CHIN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/423,104

(22) Filed: Apr. 14, 2009

(30) Foreign Application Priority Data
Apr. 14, 2008 (CN) 200810301130.3

(51) Int. Cl. H04N 7/173; G06F 15/16

(52) U.S. Cl. 725/87; 709/217

(57) ABSTRACT

An integration system of the digital content and services includes a home server and a digital media player terminal. The home server is configured to provide media content. The home server includes a favorite content recording engine for collecting favorite content. The home server is capable of receiving updated content from a remote digital content push engine. The digital media player terminal is connected to the home server. The digital media player is configured for playing the updated content.

### BACKGROUND

1. Technical Field

The present disclosure relates to an integration system of digital content and services for home entertainment.

2. Description of Related Art

A conventional home entertainment center includes a plurality of electrical devices, such as a TV, a DVD player, and a radio. The TV set may only receive a TV broadcasts, with no play on demand service available. Whereas, media can be received and played on-demand from Internet. However, media from the Internet must be processed by a computer, and it is inconvenient to integrate the Internet media with the conventional home entertainment center.

What is needed, therefore, is a convenient integration system for digital content and services.

### BRIEF DESCRIPTION OF THE DRAWINGS

FIG. 1 is a block diagram of an embodiment of an integration system for digital content and services.

FIG. 2 is a block diagram of the embodiment of a digital content push system of the integration system of FIG. 1.

FIG. 3 is a block diagram of an embodiment of a remote accessing system.

FIG. 4 is a block diagram of an embodiment of a digital media playing system.

FIG. 5 is a block diagram of an embodiment of a text to speech (TTS) system.

FIG. 6 is a block diagram of an embodiment of a home VOIP system.

FIG. 7 is a block diagram of an embodiment of a TV program recording system.

FIG. 8 is a block diagram of an embodiment of a internet browsing system.

### DETAILED DESCRIPTION

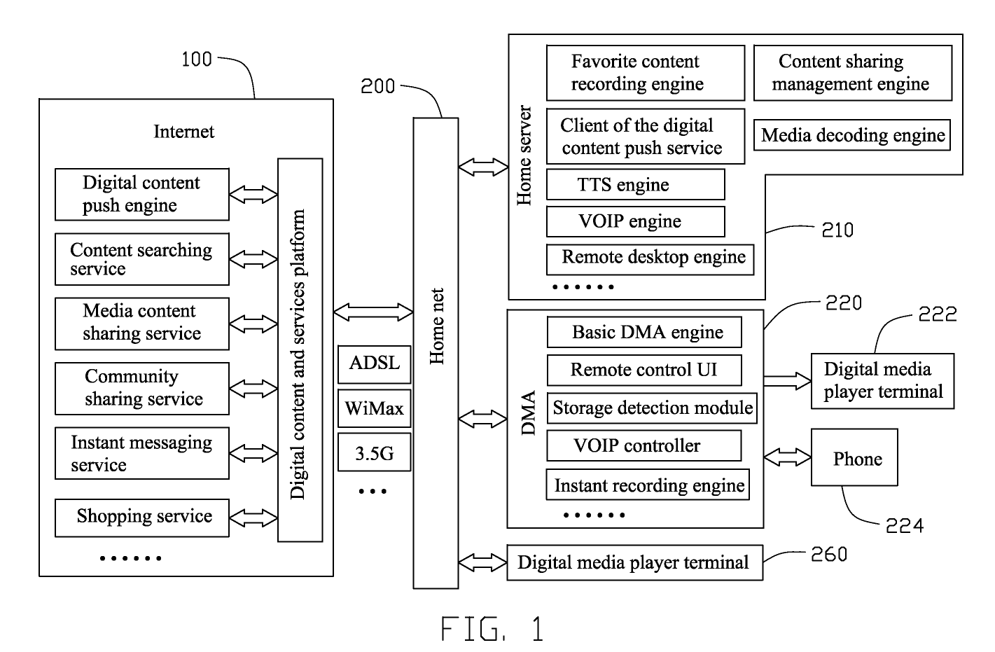

Referring to FIG. 1, a structure view of an integration system for the digital content and services is shown in one embodiment. The integration system includes the Internet 100 and a home net 200 connecting to the internet 100. The home net 200 can be connected to the Internet 100 through an asymmetric digital subscriber line (ADSL), worldwide interoperability for microwave access (WiMax), 3.5 Generations, or other similar equipment. A home server 210, a digital media adapter (DMA) 220, and a digital media player terminal 260 are connected to the home net 200. In the embodiment, the content generally refers to streaming multimedia content, and includes photo, audio, and video content.

The Internet 100 includes a digital content and services platform and a plurality of service providers (SP). The SPs can include a digital content push service, such as really simple syndication (RSS) service etc; a content searching service, an example of such is GOOGLE search engine, etc; a media content sharing service; a community sharing service, such as a blog community, an example of such is FLICKER, etc; an instant message (IM) service, examples of such are MSN, ICQ, etc; and a shopping service, an example of such is EBAY, etc.

The home server 210 is a server or computer for managing the digital content as a home digital control center. The home server 210 includes services such as media center serving, web serving, web caching, account authentication, and content storage services. Typically the home server 210 includes a favorite content recording engine to collect a history of a user's most frequent choices, a client of digital content push service corresponding to the digital content push engine from the Internet 100, a text to speech (TTS) engine, a remote desktop engine, a content sharing management engine to share content with other users through the home net or the Internet, a media decoding engine, and a voice over internet protocol (VOIP) program.

The DMA 220 is used for transforming digital content from the home server 210 to the media form files which can be directly played in a digital media player terminal 222. The DMA 220 includes a basic DMA engine, a remote control UI to control the home server 210 remotely, a storage detection module automatic plug-and-play of plugged-in storage devices and their content, a VOIP controller for VOIP connecting, a logging and configuring UI, and an instant recording module. The digital media player terminal 222, such as a display or a TV is used for playing the digital content from the DMA 220. A phone 224 can be connected to the DMA 220 to use as a VOIP phone. The digital media player terminal 220 is directly connected to the home net 200 to play media content from the home server 210. The digital media player terminal 220 can be a display such as a digital photo frame (DPF), a TV or the like.

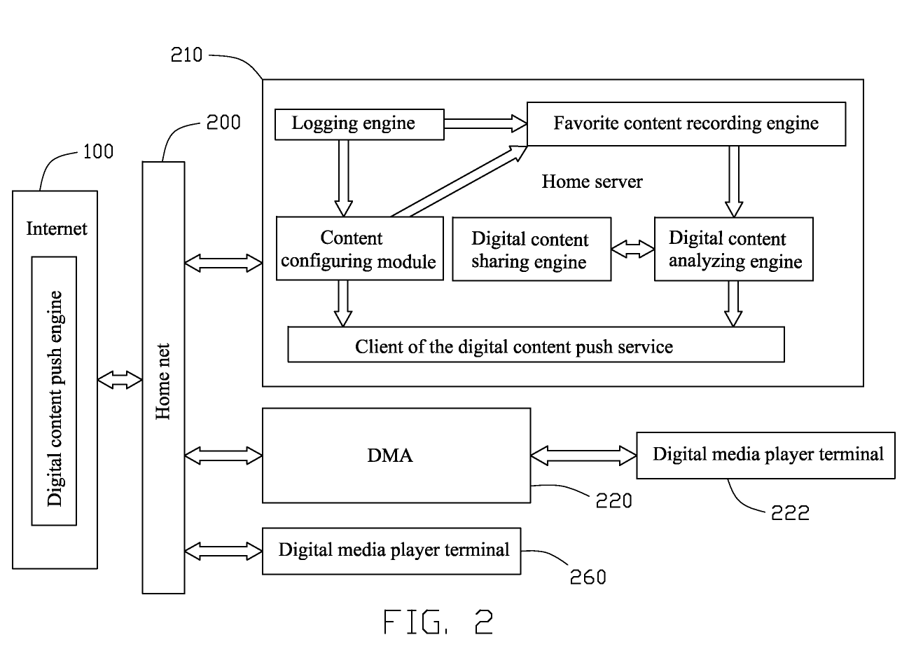

Referring to FIG. 2, a digital content push system of the integration system is shown. The home server 210 includes a favorite recording engine to collect favorite content, a digital content analyzing engine to analyze the favorite content to determine recommend content, a client of digital content push service for regularly transmitting the recommended content, which is analyzed by the digital content analyzing engine, to the remote digital content push engine. The favorite content is determined by the personal history operations of the home server. The digital content push engine may collect updated recommended content and automatically push the recommended content to the home server. The favorite content is recorded through personal operations on the home server. The favorite content includes personal media content, such as movies, TV shows, photos or music, etc, and personal services such as map access, movie rentals, Internet radio, etc.

In one embodiment, the method of receiving content from the Internet to the home net includes the following steps:

the favorite recording engine collecting favorite content from a logged user;

the digital content analyzing engine analyzing the favorite content to determine recommend content;

the client of the digital content push service receiving the recommended content and regularly contacting the digital content push engine to identify content that the users may want; and

the home server receiving a updated content automatically pushed by the digital content push engine, wherein the updated content can be stored in the home server and be presented to the digital media player terminal.

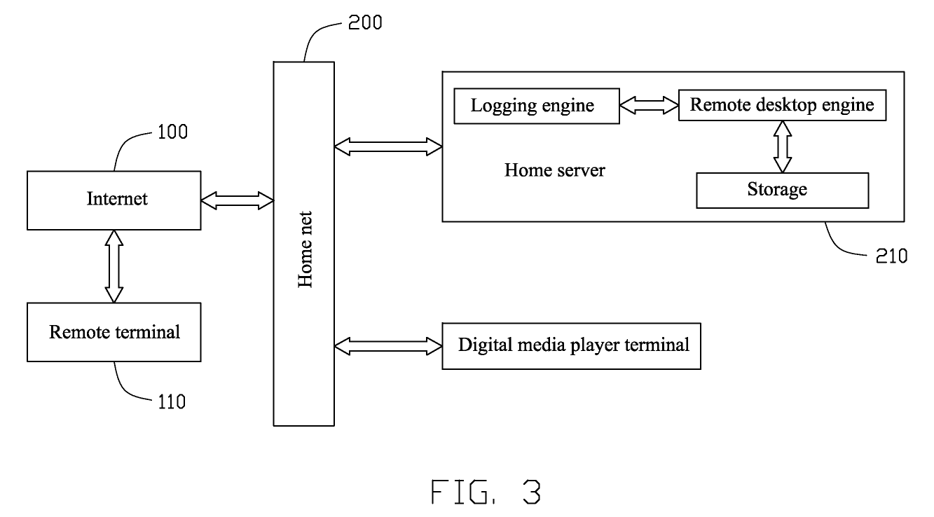

Referring to FIG. 3, a remote accessing system is shown. A remote terminal 110 can be connected to the remote desktop engine of the home server 210 through internet 100. A user logged into the home server 210 from the remote terminal 110 may leave messages, and reserve content such as photos or audio files in the home server 210. The messages, photos or audio files will be played by the digital media player terminal 260 at once when being powered up or when the same user logs into the home server 210 in the home net 200.

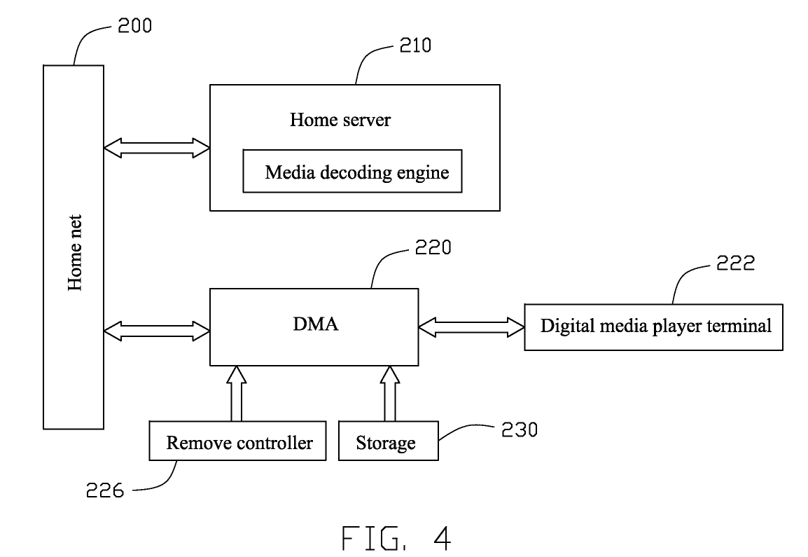

Referring to FIG. 4, a digital media playing system is shown in the embodiment. When media content in the home server is demanded for play from the DMA 220 or digital media player terminal 222, the media content is first decoded by the media decoding engine in the home server 210 and then played by the DMA 220. Alternately, the DMA 220 may also decode media content for playing the media content.

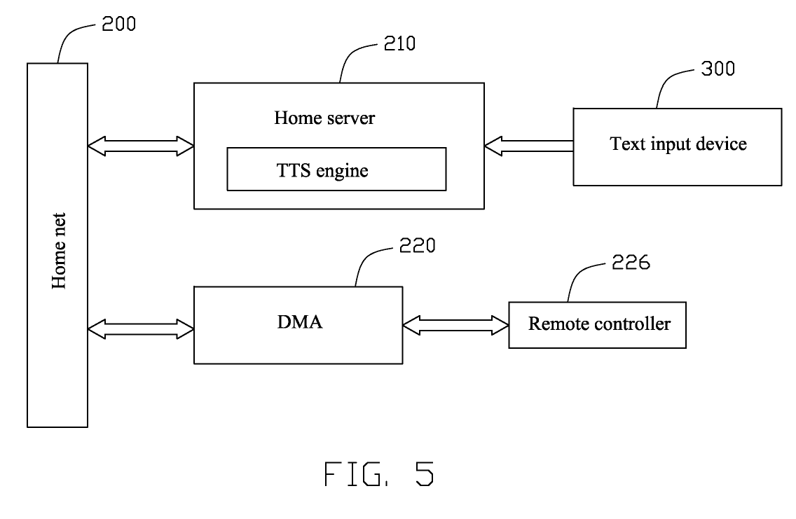

Referring to FIG. 5, a TTS system is shown in the embodiment. The home server 210 is capable of transforming a message in a text file into an audio file using the TTS engine, such that the DMA 220 will directly play the audio file from the home server 210.

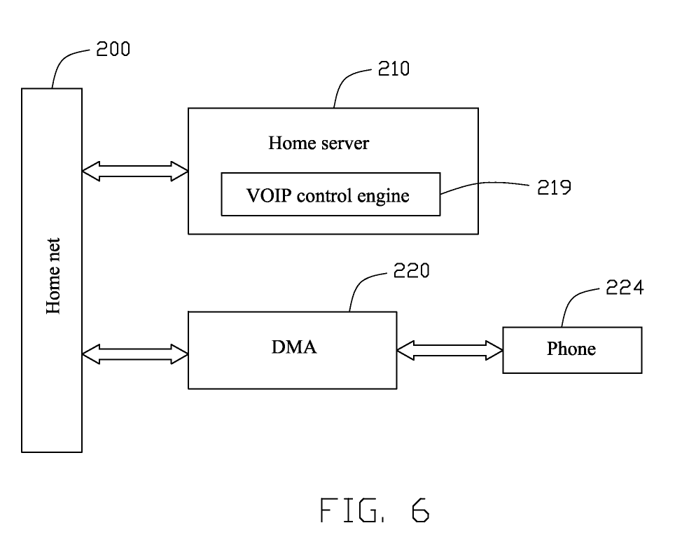

Referring to FIG. 6, a home VOIP system is shown. A phone 224 or a communicating terminal may directly connect to the DMA 220 and/or the digital media player terminal to provide telephone service through the Internet.

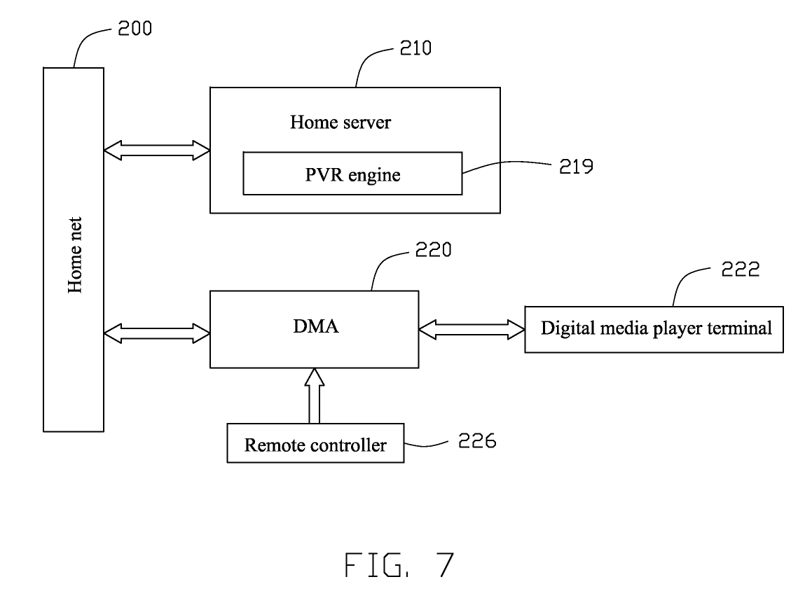

Referring to FIG. 7, a digital program recording system is shown in the embodiment. The home server 210 includes a personal video recording engine for monitoring and recording a scheduled program or a program playing in the digital media player terminal. Alternatively, the home server 210 may includes a TV card for directly receiving a TV program and transmits the TV program to the digital media player terminal 222.

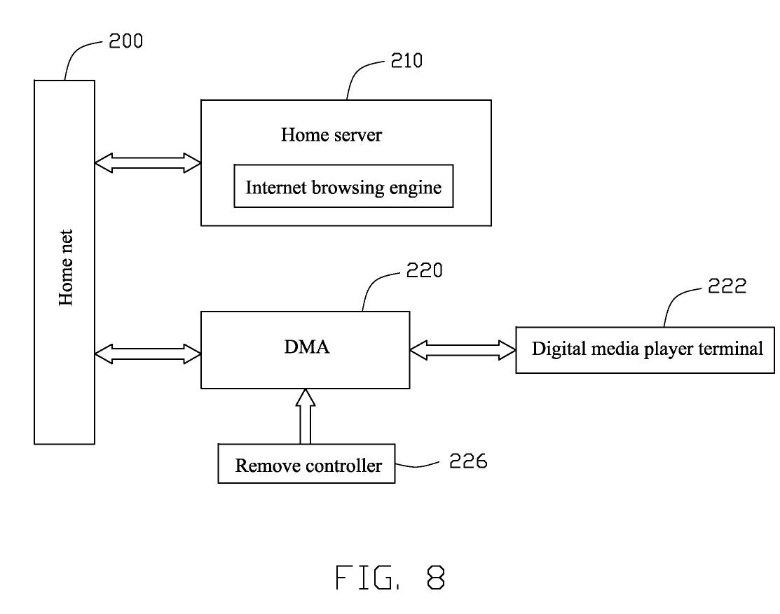

Referring to FIG. 8, a internet browsing system is shown in the embodiment. A user can browse internet through the internet browsing engine of the home server 210 by operating in DMA.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

1. An integration system for digital content and services, comprising:
a home server being configured to provide media content; the home server comprising a favorite content recording engine for collecting favorite content, and the home server being capable of receiving updated content from a remote digital content push engine; and
a digital media player terminal connected to the home server, the digital media player being configured for playing the updated content.

2. The integration system of claim 1, wherein the home server further comprises a digital content analyzing engine to analyze the favorite content to determine recommend content, a client of a digital content push engine for regularly transmitting the recommended content to the digital content push engine, and the home server is capable of receiving the updated content received by the digital content push engine.

3. The integration system of claim 2, wherein the favorite content is recorded through personal operations on the home server, and the favorite content comprises personal media content and personal services.

4. The integration system of claim 1, wherein the updated recommended content is displayed in the digital media player terminal on demand.

5. The integration system of claim 1, wherein the home server is capable of decoding media content and transmitting the decoded media content to the digital media player terminal to play directly.

6. The integration system of claim 1, wherein a remote terminal is capable of accessing the home server, and the home server is capable of recording messages from the remote terminal.

7. The integration system of claim 6, wherein the digital media player terminal displays the messages after the home server receiving the recording messages.

8. The integration system of claim 1, wherein both the home server and the digital media player terminal are capable of processing media decoding of the media content.

9. The integration system of claim 1, wherein the home server further comprises a text to speech engine for transforming a text message to a voice file.

10. The integration system of claim 1, wherein the home server is connected to the Internet, and the home server further comprises a voice over internet protocol controller.

11. The integration system of claim 1, wherein the home server comprises a personal video recorder engine for recording digital programming.

12. The integration system of claim 1, wherein a digital media adapter (DMA) is connected to the home server, the DMA comprises a media decoding engine for directly decoding media content from a remote digital content and services provider.

13. The integration system of claim 12, wherein the home server comprises an internet browsing engine, and the DMA is capable of being controlled by a remote controller.
